(19) United States
(12) Patent Application Publication
(10) Pub. No.: US 2009/0037879 A1
(43) Pub. Date: Feb. 5, 2009

(54) METHOD AND SYSTEM FOR INTEGRATING MODEL-BASED AND SEARCH-BASED AUTOMATIC SOFTWARE CONFIGURATION

(76) Inventors: Arun Kwangil Iyengar, Yorktown Heights, NY (US); Jian Yin, Bronx, NY (US)

Correspondence Address: RYAN, MASON & LEWIS, LLP, 90 FOREST AVENUE, LOCUST VALLEY, NY, 11560, US

(21) Appl. No.: 11/831,459

(22) Filed: Jul. 31, 2007

(51) Int. Cl. G06F 9/44

(52) U.S. Cl. 717/121

(57) ABSTRACT

Techniques are disclosed for integrating a model-based approach with a search-based approach for automatic configuration of a computer system. For example, in one such technique, a method for automatically configuring at least one computer system includes obtaining at least one model describing one or more effects of at least one configuration parameter on a behavior of the computer system, and modifying a process for searching for at least one acceptable value for the configuration parameter based on the model.

### FIELD OF THE INVENTION

The present invention generally relates to techniques for automatic configuration of software systems and, more particularly, to integrating model-based and search-based techniques for automatic configuration of software systems.

### BACKGROUND OF THE INVENTION

A software system (e.g., one or more software programs running on one or more computer systems) can be deployed in a wide range of environments to handle a wide range of workload requirements. The software system may also need to interact with other software systems to accomplish a task or to provide a service. Furthermore, workload requirements (or, more simply, workloads) are known to include the types of requests and the rate that requests are injected into the software system. Workloads can also include quality of service (QOS) requirements such as, for example, maximum response time. Some parts of the workload, such as the request injection rate, can change dynamically during runtime. For instance, as an electronic commerce or “e-commerce” system (one example of a software system) becomes popular, the request rate to this system increases.

To ensure the versatility of a software system for various deployment environments and workloads, the system can often have a set of parameters that can be configured to accommodate various work conditions. Parameters can generally be divided into two categories: function-related and performance-related. A function-related parameter is a parameter that ensures that a system works correctly. Setting a function-related parameter incorrectly can cause a system to crash or produce incorrect results. A performance-related parameter is a parameter that affects the system performance. Misconfiguring a performance-related parameter can prevent a system from achieving optimal performance.

However, configuring a software system can place a heavy burden on system administrators. A system administrator not only needs to have the expertise and knowledge of the system to configure it, but also needs to analyze the deployment environment and workload characteristics to achieve the correct and optimal parameter settings. Thus, automation technologies have been used to eliminate the need to configure a system manually.

An automatic configuration system can be introduced to configure a software system automatically. In general, there are two approaches for automatic configuration of software systems: search-based and model-based.

In a search-based automatic configuration approach, the automatic configuration system treats a software system as a black box and searches the range of parameter values for the correct and optimal parameter setting. However, in the search-based approach, the range of parameter values, combining with the number of parameters, results in an exponential explosion of the number of different parameter settings, and it is difficult to find the optimal parameter setting.

In a model-based automatic configuration approach, a model on how parameter settings affect the behavior of a software system is used to determine parameter settings. The disadvantage of a model-based approach is that it is difficult to have a complete and accurate model of the parameters of the software system.

### SUMMARY OF THE INVENTION

Principles of the invention provide for integrating a model-based approach with a search-based approach for automatic configuration of a computer system.

For example, in a first aspect of the invention, a method for automatically configuring at least one computer system comprises obtaining at least one model describing one or more effects of at least one configuration parameter on a behavior of the computer system, and modifying a process for searching for at least one acceptable value for the configuration parameter based on the model.

The model may be specified by an entity having domain knowledge on how one or more parameters affect the behavior of the computer system. The searching process may comprise setting at least two different values for the configuration parameter, and measuring the behavior of the computer system for each of the two different values. Automatic modification of the searching process may comprise adding or removing at least one parameter value to be tested.

The method may further comprise executing at least one workload on the computer system to determine at least one acceptable configuration parameter value. The method may further comprise measuring one or more parameter values of the computer system as the computer system processes online requests in a production environment. Further, the method may comprise continuing the searching process until a set of optimal configuration parameter values or a set of approximately optimal configuration parameter values is found. Still further, the method may comprise testing parameter values until a cost of more testing outweighs a marginal benefit of exploring a diminishing possibility or a magnitude of improving the behavior of the computer system with a new parameter value. The computer system may comprise one or more applications. The computer system may comprise one or more computing devices. One of the one or more computing devices may comprise one of a server, a model device, a sensor, a network device, and a storage device.

In a second aspect of the invention, a method for automatically configuring at least one computer system comprises obtaining at least one model, and refining the model based on a searching process performed over a given parameter value space. The model may comprise a map that maps at least one value for a parameter to a range of possible behaviors of the computer system. The model may comprise a map that maps at least one value for a parameter to at least one measurement value of the system.

In a third aspect of the invention, a method for automatically configuring at least one computer system comprises obtaining at least one model, validating the model by testing at least one selected parameter value, and based on a result of the validation step, selecting either a search-based process or a model-based process to find at least one acceptable configuration parameter value for the computer system. The model may be constructed interactively by querying a user of the computer system.

In a fourth aspect of the invention, a method for automatically configuring at least one computer system comprises obtaining a plurality of models, and utilizing a searching process to select at least one of the plurality of models that appropriately reflect how parameter values affect a behavior of the computer system. At least one of the plurality of models may comprise a map that maps at least one value for a parameter to at least one measurement value of the system.

In a fifth aspect of the invention, a method for automatically configuring at least one computer system comprises obtaining at least one model, selecting a parameter value to test based on at least one of the following criteria: (i) a benefit of testing the parameter value for refining the model; and (ii) a benefit of testing the parameter value for finding an acceptable parameter value, refining the model based on a result of the test of the selected parameter value, and iterating the parameter selecting and model refining steps.

The method may further comprise modifying the parameter selecting step by changing an order that the parameter value is tested. The method may also comprise determining whether a set of configuration parameter values is optimal based on whether a set of parameter values enables the computer system to achieve at least one of the following measurements: end-to-end latency; throughput; availability; fault tolerance; security accuracy; usability; and efficient utilization of hardware resources. Further, the method may comprise continuing the selecting step until a set of configuration values can achieve a behavior of the computer system specified by a user.

In a sixth aspect of the invention, a method for using at least one model to improve at least one search-based method for finding at least one acceptable configure parameter value of at least one computer system in production comprises using the model to select an initial setting of configuration parameters, and using the search-based method to refine the model and find improved configuration parameters. The computer system may detect changes of workload characteristics that can affect system behavior and trigger changes and search for desirable parameter setting. Changes of workload can be detected in an application specific manner.

Advantageously, the inventive methodologies permit for the use of incomplete models and/or models that are not entirely correct, thus eliminating the difficulty of attempting to construct a complete and accurate model. Furthermore, searching is used to refine and validate the model and discover appropriate parameter configuration values.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts system architecture according to an embodiment of the invention.

FIG. 2 depicts a sample computer system for use with automatic parameter configuration according to an embodiment of the invention.

FIG. 3 depicts details of a system for automatically configuring a computer system according to an embodiment of the invention.

FIG. 4 depicts a method for using both search and model to discover desirable parameter value settings according to an embodiment of the invention.

FIG. 5 depicts a method to test whether a model is correct and to choose to use either pure search or both search and model to discover desirable parameter value settings based on the results of validation according to an embodiment of the invention.

FIG. 6 depicts how an integrated automatic configuration system can use models and search to improve the process of finding appropriate configuration parameters automatically for a system in production according to an embodiment of the invention.

FIG. 7 depicts a computing system for implementing automatic configuration of a software system according to an embodiment of the invention.

### DETAILED DESCRIPTION OF PREFERRED EMBODIMENTS

Illustrative embodiments of the invention will be described below in the context of various software system examples. However, it is to be understood that principles of the invention are not limited to any particular type of software system, but rather are more generally applicable to the automatic configuration of any software system.

As mentioned above, a software system can be expected to operate in a wide range of environments: interacting with different hardware and other software to provide a service, handling different workload, etc. To ensure that a particular piece of software is flexible enough to meet various and changing needs, the software can have a large set of parameters which can take a large set of different values in different situations. As a modern computer system can be composed of many pieces of software from the lowest level to highest level of the software stack running on a cluster of machines, the number of parameters in all the pieces of software on all the machines can be very large. Those parameters must be properly configured for the system to perform well and configuring those parameters can be a complex, challenging and time-consuming task. This not only increases the cost of software ownership, but also leads to much system misbehavior caused by incorrectly configured software parameters.

Principles of the invention provide improved methodologies for automatically configuring software parameters. In general, principles of the invention combine a model-based automatic configuration approach and a search-based automatic configuration approach. In the illustrative embodiments below, we refer to an automatic configuration system that implements principles of the invention as an integrated automatic configuration system (IACS).

FIG. 1 illustrates an overall architecture according to one embodiment of the invention. This system has two major components, a computer system 20 to be configured automatically and an IACS 10 that automatically configures the system 20. The computer system can be any complex computer system that may have a large numbers of parameters that, among other things, control software system 26. IACS can include a model 11 of parameters, a search algorithm 12, and a configuration manager 13. The IACS is generic enough to automatically configure any computer system. IACS can be used to automatically discover an appropriate configuration for one workload or a set of workloads. Here the appropriate configuration means a set of parameter value assignments that result in relatively satisfactory (desirable) system properties such as (low) latency, (high) throughput, (high) availability, (high) fault tolerance, and (high) security. When IACS 10 discovers a set of appropriate configurations for a set of workloads, such information is fed to a configuration adjustor 25 that can automatically adjust system configuration for computer system 20 (i.e., software system 26) to produce desirable system properties as the workload changes.

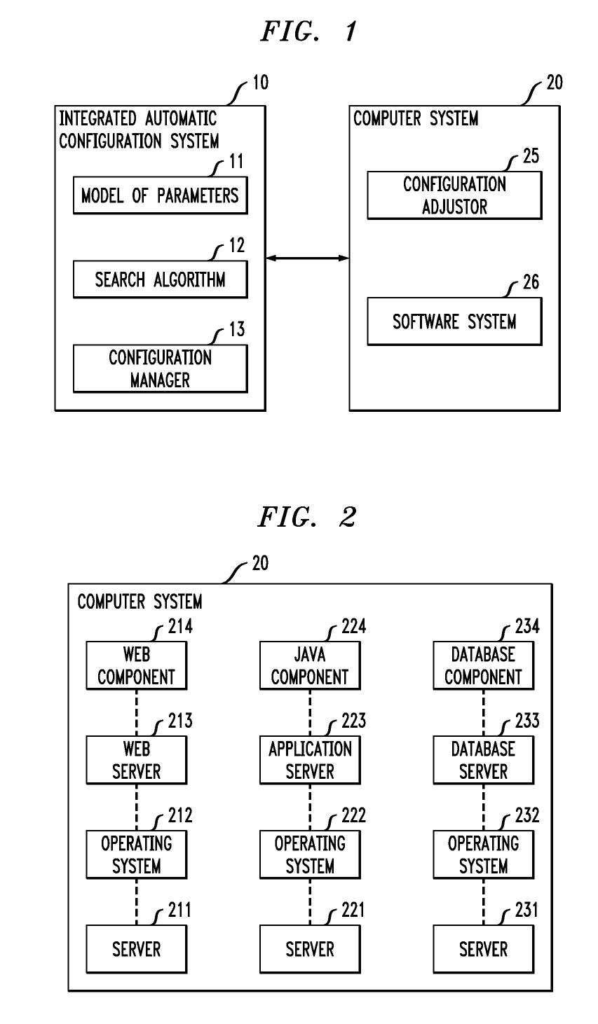

FIG. 2 illustrates a typical 3-tier e-commerce system that IACS can be used to configure. Thus, the e-commerce system in FIG. 2 can be considered as an example of computer system 20 in FIG. 1. It is to be understood that when it is stated that computer system 20 is being configured, it is generally meant that software system 26 is being configured.

E-commerce system 20 is deployed onto three physical machines, server 211, server 221, and server 231.

Server 211 is used to host the web front-end part of e-commerce system 20. Server 211 can host three levels of system stack: an operation system 212 such as Linux, a web server such as Apache Web server 213, and the web part of the application 214 which includes the set of static web pages and web plug-in to forward the dynamic requests to the application server.

Server 221 is used to host the Java processing part of e-commerce system 20. Server 221 can run a Linux operating system 222, a WebSphere application server 223, and the Java processing part 224 of the application such as a J2EE ear.

Server 231 is used to host the database. Server 231 can run an AIX (Advanced IBM Unix—IBM Corporation) operating system 232, a DB2 (IBM Corporation) database management system 233, and the database part 234 of the application including a set of tables and the data.

In such a computer system 20, each piece of software has complex interaction with another piece of software within the same machine and also with pieces of software across machines. For each piece of software, there could be hundreds of parameters to be configured. The desirable values of the configuration values depend on the underlying hardware, the interaction of the software pieces, and the characteristics of workloads.

We use several parameters to illustrate our method:

### KeepAliveTimeout in Apache Server

The Apache Web Server in the front end receives HTTP (Hypertext Transfer Protocol) requests from clients and sends the replies back through TCP (Transmission Control Protocol) connections between clients and the web server. When there is not any activity in such a connection for a period of time equal to the KeepAlive Timeout value, the server closes the connection. A client has to reestablish the connection to send requests and receive replies. The setting of this parameter can affect throughput, latency, server load, and a systems' resistance to DOS (Denial of Service) attacks. The characteristic of the workload, the power of the underlying machines, the pieces of software on each machine, and the configuration of each piece of software, all contribute to whether a value can produce desirable system behavior.

### Database Connection Pool Size in the Application Server

WebSphere servers need to communicate with database servers to retrieve or update the data managed by database servers. These connections are kept in a database connection pool. The size of connection pool can affect throughput and WebSphere server load. The workload and the software and configuration of the software in the WebSphere and Database Server all affect how such a parameter value should be chosen.

### Heap Size of Java Virtual Machines

Java applications in an application server run on a Java virtual machine. The heap size of the Java virtual machine can affect server load, throughput, and system responsiveness. The workload and the configuration of the whole system plays a role in determining the desirable value of this parameter. If this parameter is set to be too small, the communication between the application server and database can become a bottleneck, and the throughput of the system may be limited. If this parameter is set to be too large, it can waste too much memory to store the connection store. The number of connections depends on the power of the application server machine, A, the power of the database machine, D, the memory limitation in the application server, M, and the injection rate of requests, R. Thus, the optimal number of connections is a function C of A, D, M, and R.

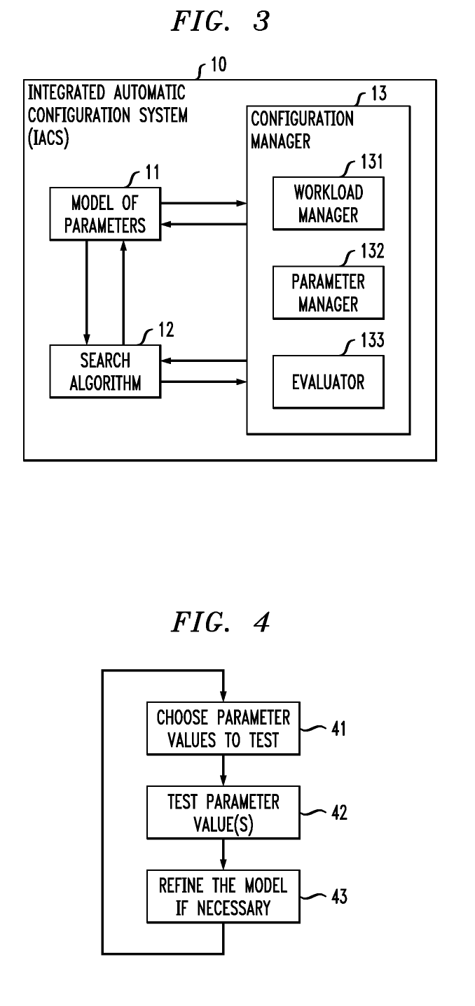

FIG. 3 illustrates the major system components of IACS 10 and how the components interact with each other. IACS 10 can include three major components: a model of configuration parameters 11, a search algorithm 12, and a configuration manager 13. Configuration manager 13 may further include a workload manager 131, a parameter manger 132, and an evaluator 133. In an offline system, workload manager 131 is responsible for sending different synthesized workloads to the tested system (computer system 20) for testing. In an online system, workload manager 131 is responsible for predicting, measuring, and reporting the online workload to the system for choosing parameter values to test.

Parameter manager 132 is responsible for setting parameters to different values for testing. Evaluation 133 is responsible for measuring the system behavior for a certain configuration and workload.

In some cases, the IACS is used to determine an appropriate configuration for a workload. Yet in other cases, the IACS is used to determine appropriate configurations for a set of workloads or for the entire workload space. Here, a workload can be described by requests patterns, such as the types of requests, the frequency of the requests, and the size of the requests. A configuration is a set of parameter settings for all the parameters in all the piece of software and hardware in the entire computer system.

System behavior can include latency, throughput, availability, fault tolerance, and security properties. Latency can be measured at the average latency, the mean latency, the worst latency, the 90-percentile latency, and so on. The throughput can be the number of requests per second for a type of requests or for a combination of several types of requests. Availability can be the percentage of system up time. This number can be derived with measurement, prediction, and calculation. Fault tolerance can be quantified as the maximum amount of partial failure that the system can survive to continue to provide the service. The security can be described by some system properties related to system security risks such as DOS attacks. For example, the larger the KeepAliveTimeout value, the more the amount of resource that an attacker with certain resource limits can take away from legitimate requests. Such numbers can be calculated by a formula programmed into the evaluator 131.

Software parameter model 11 can be a model of the effects of various parameter settings. Developers usually specify the software parameter model as they often have the most knowledge of the system. The model does not need to be complete. The thoroughness of a model can be varied across a wide spectrum. The simplest model can include categorization of function-related parameters and performance-related parameters. The model can also specify which aspect of a system can be affected by the value of a parameter. The model can also include whether or not the effects of the values of a set of parameters are independent or dependent. A more detailed model can specify more detailed relationships between parameter values and the system behavior. For instance, the value of a parameter can be specified as being correlated positively with the throughput of a system but negatively with the response time of the system. The parameter model also needs to specify the effects of the deployment environment on the optimal system parameter setting.

It is generally difficult to specify a complete model. The inventive automatic configuration system can take advantage of incomplete models and even not entirely correct model. The system can improve an incomplete model with a search in the following way.

Note that IACS 10 can have more than one model. These models can be independent. Each model covers part of parameters, part of parameter value space, part of the system behavior, and part of workload space. Alternatively, these models can all describe the effect of all the system parameters to all the system behavior. These models may disagree with each other and search algorithm 12 can test a set of parameter values to pick the most valid and accurate model or the combination of several models to be used to find appropriate (desirable) configuration parameter values.

FIG. 4 illustrates an illustrative method for IACS 10 to combine models to search to improve the process of finding appropriate parameter values. In step 41, models and search algorithms are combined to find the next parameter values to test. In step 42, the system behavior with such parameter settings is tested. Based on the results, the model can be refined in step 43 and the process is reiterated until desirable parameter values are discovered.

An incomplete model can be used to narrow down the search space for correct and optimal parameter values. For example, if the IACS knows that several parameters are independent, it can search for the optimal value for each parameter instead of searching all the combined combinations of the parameter values. Alternatively, a model can specified that some measurement of the system increases monotonously with a parameter value initially and then falls off. The database connection pool size discussed above is such an example. For such an example, a binary search can be used to find the optimal parameter values, which can significantly increase the speed of the search.

In FIG. 4, the search process can stop when the parameter setting that leads to an optimal system performance is discovered. The process can stop when approximate optimal configuration parameter values are found. That is, the parameter setting enables the system to perform within a certain range of optimal system behavior. Yet another possibility is for the process to stop when a satisfactory system behavior is achieved.

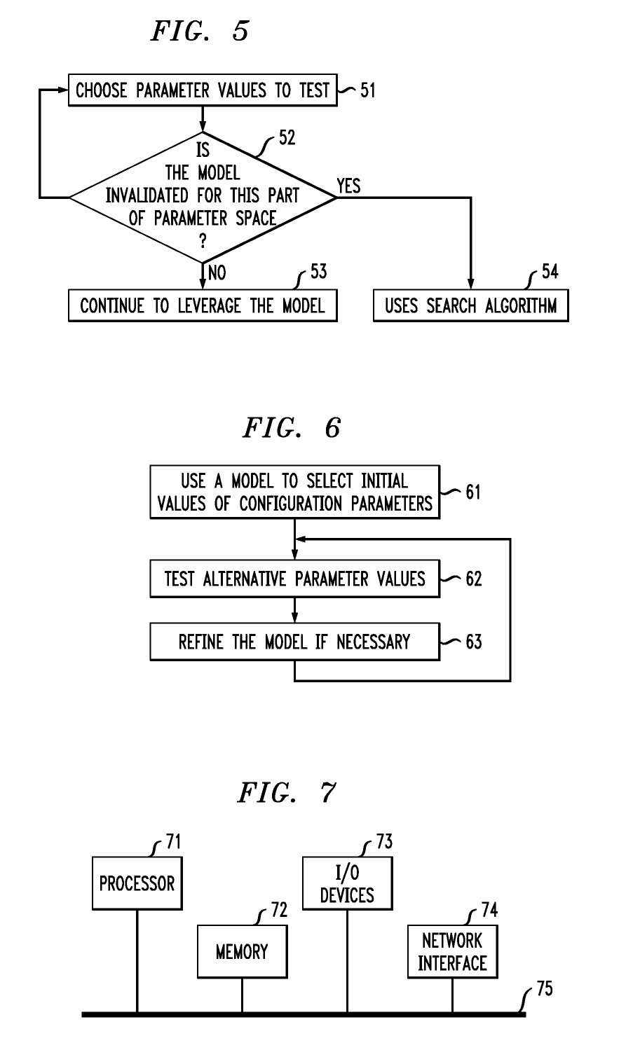

FIG. 5 illustrates how IACS 10 can check the validation of a model to choose to either use or not use the model to discover the best configuration value. The search-based approach can check the correctness of a model. If a software system is deployed into an environment that is not foreseen by the developer of a model or the workload is quite different from the assumption of the models, it is possible that some part of the model may not be correct under such circumstances. The search approach can select the correct part of the model to use and incorrect part to abandon.

In step 51, the search algorithm chooses parameter values to test based on the model. The values chosen in this step can be some values based on random sample. Alternatively, the values can be chosen biased toward best performance or toward the high likelihood to indicate whether the model is valid for a part of the parameter value space.

When a system in production needs to make a prompt adjustment as a sudden workload change causes significant system misbehavior, the IACS can use the model to get a first-order approximation of an optimal value, and then use the search approach to improve the parameter settings.

Thus, in step 52, the method determines whether or not the model is invalidated for the subject part of the parameter space. If no in step 52, the method then continues to use the model (step 53). If yes in step 52, the search algorithm is employed, as explained above (step 54).

FIG. 6 illustrates how IACS 10 can use models and searches to improve the process of finding appropriate configuration parameters automatically for a system in production. Searching for appropriate parameter values can take a long time. During this time, the system can exhibit poor performance. In step 61, the method uses an approximation to select the initial parameter value setting, which hopefully produces reasonable system performance. Then in step 62, some alternative parameter values are tested to determine whether they improve the system performance. The alternative parameter values can be chosen either to speedup the process to find the best parameter setting or to cause minimum disturbance to the system behavior. In the former case, an incremental method such as local hill climbing can be used. When a better parameter setting is discovered, an alternative parameter value is adopted and the model is refined (step 63). Step 63 can be repeated to find even better parameter values and to refine the model even further.

The workload is carefully monitored all time. When there are some changes in the workload characteristics, which can change the system behavior, the method is triggered to find an appropriate parameter setting for the changed workload. Workload changes can be detected in a generic manner or an application specific manner. In the generic manner, the system behavior is monitored when the parameter setting is fixed. When the length and magnitude of change are larger than given thresholds, the workload is assumed to be changed. In an application specific manner, the system can monitor the types and frequency of the requests to detect workload changes.

FIG. 7 illustrates a computing system wherein techniques for automatically configuring a software system may be implemented according to an embodiment of the invention. That is, FIG. 7 illustrates a computing system in accordance with which one or more components/steps of the automatic configuration techniques (e.g., components and methodologies described above in the context of FIGS. 1 through 6) may be implemented, according to an embodiment of the invention. It is to be understood that the individual components/steps may be implemented on one such computing system or on more than one such computer system. In the case of an implementation on a distributed computing system, the individual computing systems and/or devices may be connected via a suitable network, e.g., the Internet or World Wide Web. However, the system may be realized via private or local networks. In any case, the invention is not limited to any particular network.

Thus, the computing system shown in FIG. 7 may represent one or more servers or one or more other processing devices capable of providing all or portions of the functions described herein. Thus, the computing system shown in FIG. 7 may represent IACS 10 and computer system 20.

As shown, the computing system includes processor 71, memory 72, input/output (I/O) devices 73, and network interface 74, coupled via a computer bus 75 or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computing system to communicate with another computing system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for automatically configuring at least one computer system, the method comprising the steps of:
obtaining at least one model describing one or more effects of at least one configuration parameter on a behavior of said computer system; and
modifying a process for searching for at least one acceptable value for said configuration parameter based on said model.

2. The method of claim 1, wherein said model is specified by an entity having domain knowledge on how one or more parameters affect the behavior of said computer system.

3. The method of claim 1, wherein the searching process comprises the steps of:
setting at least two different values for said configuration parameter; and
measuring the behavior of said computer system for each of the two different values.

4. The method of claim 1, wherein automatic modification of the searching process comprises adding or removing at least one parameter value to be tested.

5. The method of claim 1, further comprises the step of executing at least one workload on said computer system to determine at least one acceptable configuration parameter value.

6. The method of claim 1, further comprising the step of measuring one or more parameter values of said computer system as said computer system processes online requests in a production environment.

7. The method of claim 1, further comprising the step of continuing the searching process until a set of optimal configuration parameter values is determined.

8. The method of claim 1, further comprising the step of continuing the searching process until a set of approximately optimal configuration parameter values is found.

9. The method of claim 1, further comprising the step of testing parameter values until a cost of more testing outweighs a marginal benefit of exploring a diminishing possibility or a magnitude of improving the behavior of said computer system with a new parameter value.

10. The method of claim 1, wherein said computer system comprises one or more applications.

11. The method of claim 1, wherein said computer system comprises one or more computing devices.

12. The method of claim 11, wherein one of the one or more computing devices comprises one of a server, a model device, a sensor, a network device, and a storage device.

13. An article of manufacture for automatically configuring at least one computer system, the article comprising a computer readable storage medium containing one or more computer programs which, when executed by a computer, implement the steps of claim 1.

14. A method for automatically configuring at least one computer system, the method comprising the steps of:
obtaining at least one model; and
refining said model based on a searching process performed over a given parameter value space.

15. The method of claim 14, wherein said model comprises a map that maps at least one value for a parameter to a range of possible behaviors of said computer system.

16. The method of claim 14, wherein said model comprises a map that maps at least one value for a parameter to at least one measurement value of said system.

17. An article of manufacture for automatically configuring at least one computer system, the article comprising a computer readable storage medium containing one or more computer programs which, when executed by a computer, implement the steps of claim 14.

18. A method for automatically configuring at least one computer system, the method comprising the steps of:
obtaining at least one model;
validating said model by testing at least one selected parameter value; and
based on a result of the validation step, selecting either a search-based process or a model-based process to find at least one acceptable configuration parameter value for said computer system.

19. The method of claim 18, wherein said model is constructed interactively by querying a user of said computer system.

20. An article of manufacture for automatically configuring at least one computer system, the article comprising a computer readable storage medium containing one or more computer programs which, when executed by a computer, implement the steps of claim 18.

21. A method for automatically configuring at least one computer system, the method comprising the steps of:
obtaining a plurality of models; and
utilizing a searching process to select at least one of the plurality of models that appropriately reflect how parameter values affect a behavior of said computer system.

22. The method of claim 21, wherein at least one of the plurality of models comprises a map that maps at least one value for a parameter to at least one measurement value of said system.

23. An article of manufacture for automatically configuring at least one computer system, the article comprising a computer readable storage medium containing one or more computer programs which, when executed by a computer, implement the steps of claim 21.

24. A method for automatically configuring at least one computer system, the method comprising the steps of:
obtaining at least one model;
selecting a parameter value to test based on at least one of the following criteria: (i) a benefit of testing said parameter value for refining said model; and (ii) a benefit of testing said parameter value for finding an acceptable parameter value;
refining said model based on a result of the test of said selected parameter value; and
iterating the parameter selecting and model refining steps.

25. The method of claim 24, further comprising modifying the parameter selecting step by changing an order that the parameter value is tested.

26. The method of claim 24, further comprising the step of determining whether a set of configuration parameter values is optimal based on whether a set of parameter values enables the computer system to achieve at least one of the following measurements: end-to-end latency; throughput; availability; fault tolerance; security accuracy; usability; and efficient utilization of hardware resources.

27. The method of claim 24, further comprising the step of continuing the selecting step until a set of configuration values can achieve a behavior of the computer system specified by a user.

28. An article of manufacture for automatically configuring at least one computer system, the article comprising a computer readable storage medium containing one or more computer programs which, when executed by a computer, implement the steps of claim 24.

29. A method for using at least one model to improve at least one search-based method for finding at least one acceptable configure parameter value of at least one computer system in production, the method comprising the steps of:
using said model to select an initial setting of configuration parameters; and
using said search-based method to refine said model and find improved configuration parameters.

30. The method of claim 29, wherein said computer system detects changes of workload characteristics that can affect system behavior and trigger changes and search for desirable parameter setting.

31. The method of claim 30, wherein changes of workload can be detected in an application specific manner.

32. An article of manufacture for using at least one model to improve at least one search-based method for finding at least one acceptable configure parameter value of at least one computer system in production, the article comprising a computer readable storage medium containing one or more computer programs which, when executed by a computer, implement the steps of claim 29.

33. Apparatus for automatically configuring at least one computer system, the apparatus comprising at least one processor configured to: obtain at least one model describing one or more effects of at least one configuration parameter on a behavior of said computer system; and modify a process for searching for at least one acceptable value for said configuration parameter based on said model.

34. Apparatus for automatically configuring at least one computer system, the apparatus comprising at least one processor configured to: obtain at least one model; and refine said model based on a searching process performed over a given parameter value space.

35. Apparatus for automatically configuring at least one computer system, the apparatus comprising at least one processor configured to: obtain at least one model; validate said model by testing at least one selected parameter value; and based on a result of the validation step, select either a search-based process or a model-based process to find at least one acceptable configuration parameter value for said computer system.

36. Apparatus for automatically configuring at least one computer system, the apparatus comprising at least one processor configured to: obtain a plurality of models; and utilize a searching process to select at least one of the plurality of models that appropriately reflect how parameter values affect a behavior of said computer system.

37. Apparatus for automatically configuring at least one computer system, the apparatus comprising at least one processor configured to: obtain at least one model; select a parameter value to test based on at least one of the following criteria: (i) a benefit of testing said parameter value for refining said model; and (ii) a benefit of testing said parameter value for finding an acceptable parameter value; refine said model based on a result of the test of the said selected parameter value; and iterate the parameter selecting and model refining operations.

38. Apparatus for using at least one model to improve at least one search-based method for finding at least one acceptable configure parameter value of at least one computer system in production, the apparatus comprising at least one processor configured to: use said model to select an initial setting of configuration parameters; and use said search-based method to refine said model and find improved configuration parameters.
